(19) United States
(12) Patent Application Publication
(10) Pub. No.: US 2006/0006241 A1
(43) Pub. Date: Jan. 12, 2006

(54) Data support having several electronic modules mounted on the same surface

(76) Inventors: Alain Soyer, Les Preaux (FR); Dorothee Nerot, Orleans (FR); Yves Reignoux, Clery Saint-Andre (FR)

Correspondence Address: OSHA LIANG L.L.P., 1221 MCKINNEY STREET, SUITE 2800, HOUSTON, TX, 77010, US

(21) Appl. No.: 10/531,550

(22) PCT Filed: Oct. 23, 2003
(86) PCT No.: PCT/IB03/04690

§ 371 Date: Apr. 15, 2005

(30) Foreign Application Priority Data
Oct. 24, 2002 (EP) 02292649.7
Apr. 23, 2003 (EP) 03076180.3

(51) Int. Cl. G06K 19/06

(52) U.S. Cl. 235/492

(57) ABSTRACT

According to some embodiments, a portable object includes a first side and a second side. The first side of the portable object is provided with a first electronic information support and with a second electronic information support. According to other embodiments, a method of manufacturing a portable object is provided. In a first cavity creation step, a first cavity is created in the first side of the portable object. In a second cavity creation step, a second cavity is created in the first side of the portable object.

### FIELD OF THE INVENTION

This invention concerns a portable object comprising several electronic information supports and a method to manufacture such a portable object. The portable object may in particular be a card in ISO 7816 format. An electronic information support comprises a support body in which an integrated circuit arranged to store and/or process data is inserted. The integrated circuit may be included in a module. A module comprises an integrated circuit connected to contact pads via, for example, conducting wires or conducting balls. The conducting wires and the integrated circuit are generally coated with a protective resin.

### BACKGROUND OF THE INVENTION

The electronic information support may be, for example, a 2G (2nd generation) SIM (Subscriber Identity Module) card. A 2G SIM card is generally the part of a card in ISO 7816 format which is inserted in a mobile telephone. The electronic information support may also be a 3G (3rd generation) USIM card. Currently, as illustrated on FIG. 1, a module (1) is embedded in a card (2) from which a 2G SIM card is cut (3). The 2G SIM card (3) is then personalised both as regards the software and the graphics. The 2G SIM card (3) can then be detached from the card (2) ready for use. Thus one single 2G SIM card is produced per ISO 7816 card (2).

### SUMMARY OF THE INVENTION

This is an objective of the invention to offer cost savings.

According to one aspect of the invention, a portable object comprising a first side and a second side, the first side being provided with a first electronic information support, is characterised in that the first side is further provided with a second electronic information support.

The portable object may be in particular a card with the format of a smart card as defined in standard ISO 7816. The electronic information supports may be in particular 2G SIM cards. Several 2G SIM cards may therefore be manufactured from the same card. Consequently, less material is used. In addition, since there are several electronic information supports on the same card and on the same side, the machines can operate at higher rates during the various manufacturing steps. The invention therefore provides a means of reducing manufacturing costs.

### BRIEF DESCRIPTION OF THE DRAWINGS

FIG. 1 illustrates a module embedded in a card (2) from which a 2G SIM card is cut; and

FIG. 2 illustrates a method of manufacturing 2G SIM cards according to the invention.

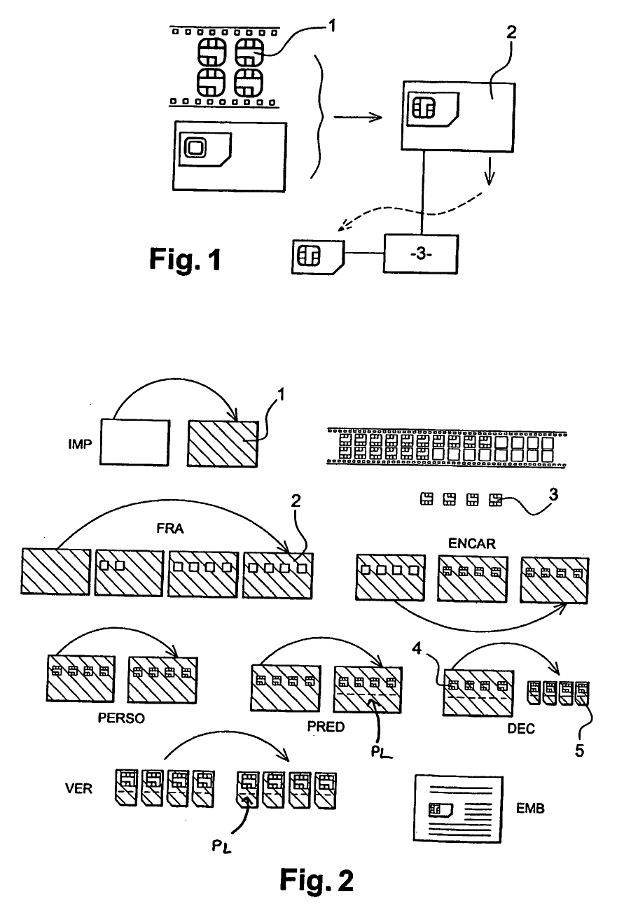

### DETAILED DESCRIPTION

To provide a better understanding of the invention, we will now describe a special mode of realisation of the invention, using FIG. 2 as an illustration.

In a printing step IMP, a card (1), preferably initially blank, is advantageously printed, for example with an advertising graphic, to obtain a printed card. Advantageously the card (1) is a right parallelepiped with the format of a smart card as defined in standard ISO 7816.

In a cavity creation step FRA, four cavities (2) are created in a printed card. The cavities are created, for example, by milling. Advantageously, a cavity comprises two sub-cavities; i.e. a first sub-cavity and a second sub-cavity arranged to house the part of a module which is coated with protective resin. Advantageously, as illustrated on FIG. 2, the cavities are created on the same side of the card so as to both simplify the manufacturing process and reduce the manufacturing cost. Advantageously, as illustrated on FIG. 2, the cavities are aligned so as to both simplify the manufacturing process and reduce the manufacturing cost.

In an embedding step ENCAR, modules (3) are cut into a strip of modules for insertion in the cavities of the printed card. An embedded card is therefore obtained.

In a personalisation step PERSO, the embedded card is personalised. The personalisation step comprises:
a software personalisation sub-step in which the integrated circuits of the modules are programmed; and
a graphic personalisation sub-step in which the areas corresponding to the support bodies of the future 2G SIM cards are graphically personalised. For example, a Personal Identification Number (PIN) can be printed.

In a precutting step PRED, the card may advantageously be marked with a precut line (PL). This precut line (PL) will be used later to cut the 2G SIM cards into the format of a 3G USIM card.

In a cutting step DEC, four 2G SIM cards are cut in the card (1).

In a verification step VER, the order of the personalised 2G SIM cards is checked. Once the 2G SIM cards have been personalised, in fact, they must be delivered to the customer in order and with no gaps in the numbering.

In a packaging step EMB, each 2G SIM card is placed in its associated insert. Consequently, the customer no longer receives a 2G SIM card inserted in an ISO 7816 format card, but instead a 2G SIM card associated with an insert.

The above description illustrates a portable object comprising a first side and a second side. The first side is provided with a first electronic information support. The first side is further provided with a second electronic information support.

The description of the special mode of realisation illustrates rather than limits the invention. It is clear that there are numerous alternatives. In this context, the following closing remarks can be made.

In the above description, the portable object was a card with the format of a smart card as defined in standard ISO 7816. The invention concerns any other portable object with different dimensions and different shape.

In a milling step FRA, cavities are milled out. Techniques other than milling can be used. In particular, the cavities can be obtained by moulding.

In addition, in the above mode of realisation, a card (1) comprises four 2G SIM cards. More generally, it concerns cards comprising at least two 2G SIM cards.

Note that in the above description, the 2G SIM cards are advantageously arranged on the same side of the card (1). However, the 2G SIM cards could also be located on both sides of the card (1). In this case, the two 2G SIM cards are advantageously opposite each other so as to limit the machine modifications whilst keeping the standard configuration.

The precutting step PRED, used to precut the 2G SIM cards into the format of a 3G USIM card, may take place before the personalisation step. In addition, this step is optional; it is not a necessary part of the invention.

Note that in the above description, the electronic information supports can be detached from the card. However, the invention also concerns cards comprising electronic information supports, which are not detachable.

What is claimed is:

1. A portable object comprising a first side and a second side of the portable object, the first side of the portable object being provided with a first electronic information support, and with a second electronic information support.

2. The portable object according to claim 1, wherein the first and second electronic information support are aligned.

3. The portable object according to claim 1, wherein the first electronic information support comprises a support body in which an integrated circuit is inserted and wherein the integrated circuit is arranged to store and process data.

4. The portable object according to claim 1, wherein the first electronic information support is arranged to be detached from the portable object.

5. The portable object according to claim 1, wherein the portable object has the shape of a right parallelepiped with the format of a smart card as defined in International Organization for Standardization standard ISO 7816.

6. The portable object according to claim 2, wherein the first electronic information support is a second generation SIM card.

7. The portable object according to claim 6, wherein the second generation SIM card comprises a precut area.

8. A method of manufacturing a portable object, the portable object comprising a first side and a second side, the method comprising:
a first cavity creation step, in which a first cavity is created in the first side of the portable object: and
a second cavity creation step, in which a second cavity is created in the first side of the portable object.

9. The method according to claim 8, further comprising an embedding step in which modules are inserted in the first cavity and in the second cavity.

10. The method according to claim 8, wherein the cavities are created by milling.

11. The method according to claim 8, wherein the cavities are created by molding.
